(19) United States
(12) Patent Application Publication
(10) Pub. No.: US 2018/0068361 A1
(43) Pub. Date: Mar. 8, 2018

(54) Offer Eligibility Checker Based on End-User's Domain

(71) Applicant: Microsoft Technology Licensing, LLC, Redmond, WA (US)

(72) Inventors: Biswa Ranjan Behera, Redmond, WA (US); Pablo Martins, Seattle, WA (US); Matthew Kotler, Sammamish, WA (US); Sapan Sarvaiya, Redmond, WA (US)

(21) Appl. No.: 15/255,170

(22) Filed: Sep. 2, 2016

(51) Int. Cl. G06Q 30/06

(52) U.S. Cl. CPC G06Q 30/0609

(57) ABSTRACT

A method of determining eligibility of an end-user for a product option is disclosed. The method receives persona information from an end-user, wherein the persona information includes an email address having a domain name. The method determines eligibility for a product option based on the persona information. The method presents the product option to the end-user and signs up the end-user with the product option.

### BACKGROUND

Computer users often download software to or access Internet-bases software from their local computers from servers on the Internet. This provides for a more convenient and efficient method of distributing software than purchasing physical media from a retail outlet. Often such computer users, known as end-users will be eligible to receive certain software based on various criteria. The various criteria determine eligibility for particular offers for the software. For example, a first offer may be available for a student; a second offer may be available for staff; and a third offer may be available for faculty. Software servers need to able to check offer eligibility for specific end-users.

### SUMMARY

Non-limiting examples of the present disclosure describe a method of checking offer eligibility. The method receives persona information from an end-user, wherein the persona information includes an email address having a domain name. The method determines eligibility for a product option based on the persona information. The method presents the product option to the end-user and signs up the end-user with the product option.

Further non-limiting examples of the present disclosure describe a system for checking offer eligibility. The system includes: at least one processor; and a memory operatively connected with the at least one processor storing computer-executable instructions that, when executed by the at least one processor, causes the at least one processor to execute a method. The method receives an end-user's email address and secondary information. The method determines eligibility for a product option based on the domain name in the end-user's email address and secondary information. And, the method presents the end-user with the product option for which he is determined to be eligible.

Further non-limiting examples of the present disclosure describe a non-transitory machine readable storage medium having stored thereon a computer program. The computer program comprises a routine of set instructions for causing the machine to perform the operations of: receiving an email address having a domain name and secondary information from an end-user; extracting an end-user's organization from the domain of the email address; determining eligibility for a product option based on the end-user's organization and secondary information; and presenting the end-user with an eligible product option.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Non-limiting and non-exhaustive examples are described with reference to the following figures.

FIG. 1 illustrates a system that allows an end-user to connect to a software server through a network and download software according to aspects of the present disclosure.

FIG. 2 illustrates a flow chart of the Offer Eligibility Checker Engine at which aspects of the present disclosure may be directed.

FIG. 3 is a block diagram illustrating physical components (e.g., hardware) of a computing device with which aspects of the disclosure may be practiced.

### DETAILED DESCRIPTION

The following detailed description refers to the accompanying drawings. Wherever possible, the same reference numbers are used in the drawings and the following description refers to the same or similar elements. While examples may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description is not limiting, but instead, the proper scope is defined by the appended claims. Examples may take the form of a hardware implementation, or an entirely software implementation, or an implementation combining software and hardware aspects. The following detailed description is, therefore, not to be taken in a limiting sense.

An Offer Eligibility Checker Engine serves to check whether a user with a particular persona is eligible for product. Product may include, for example, software, digital content, or physical content. Various versions of product may be available for an end-user depending upon various factors. Such factors may include, for example, the organization of which an end-user is associated and secondary information, such as, the position of the end-user within the organization, mission of the organization, or eligibility documentation. For example, an end-user may provide email address that indicates what organization an end-user is associated with and may also provide the position of the end-user within the organization. Based on this information, the Offer Eligibility Checker Engine may consult, for example, a database to determine what offers are available for the end-user. The Offer Eligibility Checker Engine may, in alternative embodiments, consult a text file or XML file, for example, to determine what offers are available for the end-user

For example, an end-user may be a student in a university. The end-user may provide his email address, e.g., user@school.edu, as well as his position within the school, e.g., student. Based on this information, the Offer Eligibility Checker Engine would determine what product options are available for the end-user, display a list of the options to the end-user, permit the end-user to select an option, and provide the selected product option to the end-user. These product options may be in the form of different Stock Keeping Units (“SKU's”) of product. Product SKU's may be ordered in groups in different levels. For example, the most complete product packages with the most features may have one or more SKU's and be set at level 1; product with fewer feature may have its SKU set at level 2; and product with the fewest features may have its SKU set at level 3. As mentioned above, there may be multiple SKU options at each level with each SKU being a different version of the product with different features.

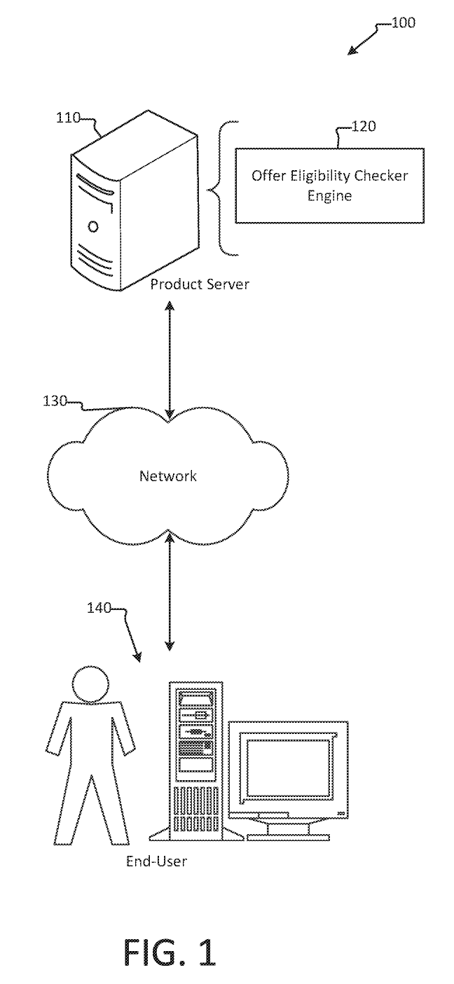

FIG. 1 illustrates an aspect of a system 100 that allows an end-user 140 to connect to a product server 110 through a network 130 and retrieve product according to aspects of the present disclosure. A product server 110 is a device that provides an interface to permit an end-user to purchase and download product. An end-user 140 can include anyone with access to a computing device that is connected to the product server 110 through a network 130. A computer network includes any connections between computing devices for the purpose of sharing resources such as local area networks, wide area networks, and the Internet. In this case, the product server hosts an Offer Eligibility Checker Engine 120 that allows for receiving information about the persona, e.g., organization and position, of an end-user and determining the eligibility of the end-user for particularly product SKU's. The Offer Eligibility Checker Engine 120 may be hosted on the product server 110 or the product server 110 may access a different server that hosts the Offer Eligibility Checker Engine 120. Through the later arrangement, the product server 110 uses a remote server hosting the Offer Eligibility Checker Engine 120 to determine the eligibility of an end-user for specific product SKU's.

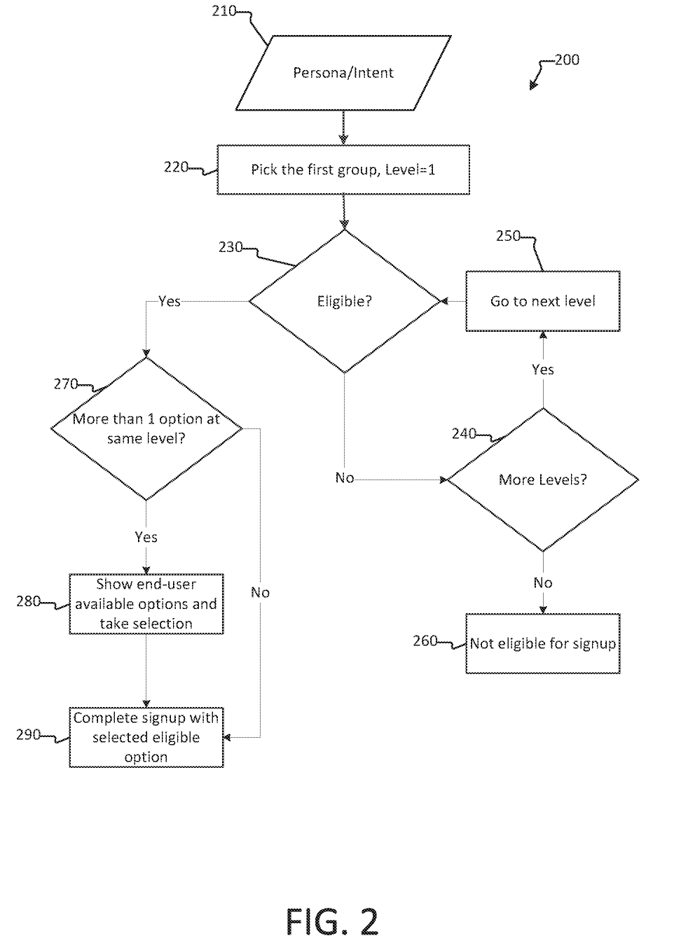

FIG. 2 illustrates a flow chart of the Offer Eligibility Checker Engine 200 at which aspects of the present disclosure may be directed. Initially the end-user's email and position within the organization are received from the end-user (stage 210). The Offer Eligibility Checker Engine then sets the initial level to check at level 1 (stage 220). Based on the end-user's email (from which the end-user's organization may be determined by examining the domain in the end-user's email address) and secondary information, such as position within the organization, mission of the organization, or eligibility documentation, a determination is made as to whether the end-user is eligible for product at the current level (initially level 1) (stage 230).

If the end-user is eligible for the checked level of product, flow proceeds to stage 270 where the end user will be presented with product options; however, if the end-user is not eligible for the checked level of product, a check is made to determine if more levels of product are available (stage 240). If no more levels are available, it is determined that the end-user is not eligible for product by virtue of his organization and/or position and the end-user is notified that he is not eligible for the product specials (stage 250). In addition, at this determination of ineligibility, the end-user may be directed to where he can purchase retail versions of the product, a support site, or receive an error message.

If more levels are available, the next level of product is selected (stage 250) and eligibility is once again checked at this newer level (stage 230).

Returning to the flow if an end-user is deemed eligible for product at a particular level, a check is made as to whether there is more than one option of product, i.e., multiple SKU's, available at this level (stage 270). If so, the end-user is presented with a list of available options of product and the selection is received from the end-user (stage 280) and flow proceeds to stage 290. To determine the list of available options of product, the Offer Eligibility Checker Engine may have various methods to determine what to present. For example, the least expensive option may be presented, the version with the most functionality may be presented, or the version that is most appropriate for the end-user based on the organization and secondary information may be presented. If not, signup is completed with the eligible product option (stage 290) and the end-user may proceed to have access to the product for which she signed up.

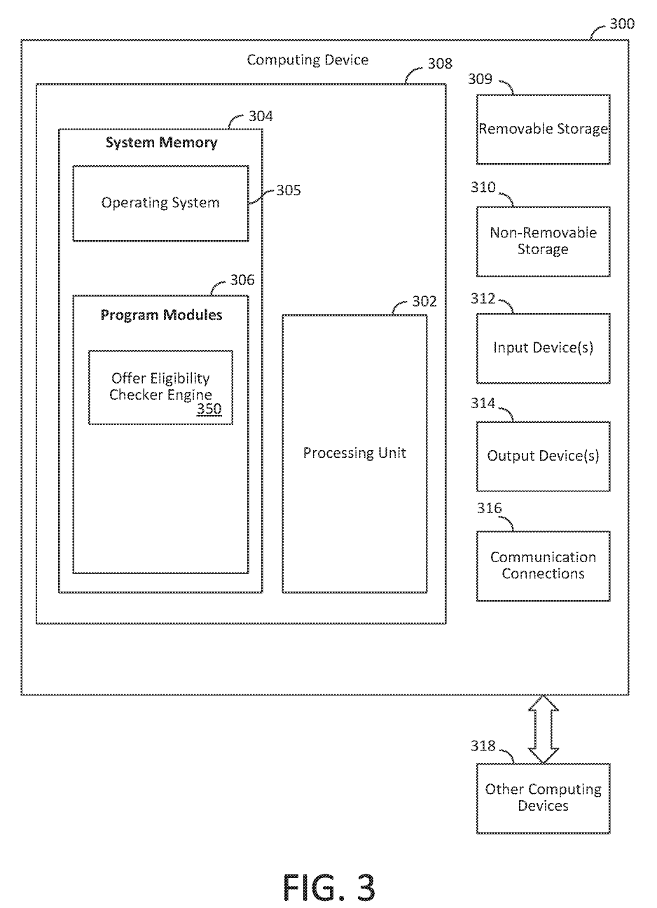

FIG. 3 is a block diagram illustrating physical components (e.g., hardware) of a computing device 300 with which aspects of the disclosure may be practiced. The computing device components described below may have computer executable instructions for implementing an offer eligibility checker engine 350 on a computing device, including computer executable instructions that can be executed to implement the methods disclosed herein. In a basic configuration, the computing device 300 may include at least one processing unit 302 and a system memory 304. The computing device 300 may be, for example, a server, a desktop computer, a portable computer, or a mobile computing device. Depending on the configuration and type of computing device, the system memory 304 may comprise, but is not limited to, volatile storage (e.g., random access memory), non-volatile storage (e.g., read-only memory), flash memory, or any combination of such memories. The system memory 304 may include an operating system 305 and one or more program modules 306 suitable for running offer eligibility checker engine application 350.

The operating system 305, for example, may be suitable for controlling the operation of the computing device 300. Furthermore, embodiments of the disclosure may be practiced in conjunction with a graphics library, other operating systems, or any other application program and is not limited to any particular application or system. This basic configuration is illustrated in FIG. 3 by those components within a dashed line 308. The computing device 300 may have additional features or functionality. For example, the computing device 300 may also include additional data storage devices (removable and/or non-removable) such as, for example, magnetic disks, optical disks, or tape. Such additional storage is illustrated in FIG. 3 by a removable storage device 709 and a non-removable storage device 310.

As stated above, a number of program modules and data files may be stored in the system memory 304. While executing on the processing unit 302, the program modules 306 (e.g., offer eligibility checker engine application 350) may perform processes including, but not limited to, the aspects, as described herein. Other program modules may be used in accordance with aspects of the present disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 3 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 300 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

The computing device 300 may also have one or more input device(s) 312 such as a keyboard, a mouse, a pen, a sound or voice input device, a touch or swipe input device, etc. The output device(s) 314 such as a display, speakers, a printer, etc. may also be included. The aforementioned devices are examples and others may be used. The computing device 300 may include one or more communication connections 316 allowing communications with other computing devices 318. Examples of suitable communication connections 316 include, but are not limited to, radio frequency (RF) transmitter, receiver, and/or transceiver circuitry, universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 304, the removable storage device 309, and the non-removable storage device 310 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 300. Any such computer storage media may be part of the computing device 300. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

The description and illustration of one or more examples provided in this application are not intended to limit or restrict the scope as claimed in any way. The aspects, examples, and details provided in this application are considered sufficient to convey possession and enable others to make and use the best mode. Implementations should not be construed as being limited to any aspect, example, or detail provided in this application. Regardless of whether shown and described in combination or separately, the various features (both structural and methodological) are intended to be selectively included or omitted to produce an example with a particular set of features. Having been provided with the description and illustration of the present application, one skilled in the art may envision variations, modifications, and alternate examples falling within the spirit of the broader aspects of the general inventive concept embodied in this application that do not depart from the broader scope.

We claim:

1. A method, comprising:
receiving persona information from an end-user, wherein the persona information includes an email address having a domain name;
determining eligibility for a product option based on the persona information;
presenting the product option to the end-user; and
signing up the end-user with the product option.

2. The method of claim 1, wherein determining eligibility further comprises:
selecting a level of product to check for eligibility; and
determining whether the end-user is eligible for the selected level of product option.

3. The method of claim 2, wherein presenting the product option to the end-user further comprises:
presenting a plurality of product options to the end user at the selected level of product.

4. The method of claim 3, further comprising receiving a selected product option from the presented plurality of product options.

5. The method of claim 4, wherein signing up the end-user with the product option further comprises signing up the end-user with the selected product option.

6. The method of claim 2, further comprising, if the end-user is not eligible for the selected level of product, incrementing the level of product and determining whether the end-user is eligible for the incremented level of product.

7. The method of claim 2, further comprising, if the end-user is not eligible for the selected level of product and no further increments of product levels are available, notifying the end-user that she is not eligible for the product.

8. The method of claim 7, further comprising notifying the end-user about other options to attain comparable product.

9. A system, comprising:
at least one processor; and
memory, operatively connected to the at least one processor and storing instructions that, when executed by the at least processor, cause the at least one processor to perform a method for generating the display of specific secondary content, the method comprising:
receiving an end-user's email address having a domain name and secondary information;
determining eligibility for a product option based on the domain name in the end-user's email address and secondary information; and
presenting the user with the product option for which he is determined to be eligible.

10. The system of claim 9, wherein the method further comprises signing up the end-user with the eligible product option.

11. The system of claim 9, wherein the method further comprises setting a level of product options to determine eligibility at a highest level.

12. The system of claim 11, wherein the method further comprises determining eligibility for the product options at the level.

13. The system of claim 12, wherein the method further increments the level if it is determined that the end-user is not eligible for product options at the current level and determining if the end-user is eligible for product options at the incremented level.

14. The system of claim 13, wherein the method further comprises presenting the end-user with a plurality of product options at the current level and receiving a selection of a product options from the end user.

15. The system of claim 14, wherein the method further comprises signing up the end-user with the selected product option.

16. A non-transitory machine readable storage medium having stored thereon a computer program, the computer program comprising a routine of set instructions for causing the machine to perform the operations of:
receiving an email address having a domain name and secondary information from an end-user;
extracting an end-user's organization from the domain name of the email address;
determining eligibility for a product option based on the end-user's organization and secondary information; and
presenting the end-user with an eligible product option.

17. The non-transitory machine readable storage medium of claim 16, further comprising instructions for signing up an end-user with the eligible product option.

18. The non-transitory machine readable storage medium of claim 16, further comprising instructions for providing the end-user with an alternative means of acquiring comparable product if the end-user is not eligible for a product option.

19. The non-transitory machine readable storage medium of claim 16, further comprising instructions for setting a level of product options and determining eligibility for the level of product options.

20. The non-transitory machine readable storage medium of claim 19, further comprising instructions for presenting the user with a plurality of product options at the selected level and receiving from the end-user a selected product option.
